(19) United States
(12) Patent Application Publication
(10) Pub. No.: US 2014/0253457 A1
(43) Pub. Date: Sep. 11, 2014

(54) Inputting Chinese Characters

(71) Applicant: JETZI, INC.,, Belmont, MA (US)

(72) Inventor: BERLING LEE, VICTORIA (CA)

(73) Assignee: JETZI, INC., BELMONT, MA (US)

(21) Appl. No.: 13/789,054

(22) Filed: Mar. 7, 2013

(51) Int. Cl. G06F 3/01

(52) U.S. Cl. CPC G06F 3/018
USPC 345/171; 345/173

(57) ABSTRACT

Among other things, a method for use in causing Chinese characters that comprise shape elements to be constructed by an electronic device is described. A user is enabled to enter any of a set of Chinese characters sufficient to enable typical communication to a Chinese reader. The method comprises associating groups of shape elements with respective non-numerically associated touch locations of the electronic device, and upon receipt of an indication that one or more of the touch locations have been invoked, constructing a Chinese character based on the shape elements associated with the invoked touch locations. The shape elements are a complete set of shape elements from which all Chinese characters in the set are formed. Every one of the shape elements belongs to one of the groups. All shape elements in each group resemble each other in shape.

### TECHNICAL FIELD

This invention relates to inputting Chinese characters.

### BACKGROUND

Chinese characters are represented by logograms that are not necessarily associated with the pronunciation of the characters. In order to input a Chinese character into a digital device such as a computer or cell phone, each Chinese character is mapped to one or more input keystrokes. There are two types of methods of mapping Chinese characters to input keystrokes. One method is based on sound. The pronunciation of the Chinese character is phonetically represented using the English alphabet. Each Chinese character is mapped to its phonetic representation in English. A requirement for using a sound-based method is that the user must know how the Chinese character is pronounced.

The second type of Chinese character input method is based on shape. Each Chinese character is composed of one or more shape elements. In a shaped-based input method, the shape elements are mapped to keystrokes. Each Chinese character is represented by one or more keystrokes that are mapped to one or more shape elements. Using a combination of shape elements in a specified sequence identifies a Chinese character.

### SUMMARY

In one aspect, the disclosure features a method for use in causing Chinese characters that comprise shape elements to be constructed by an electronic device. A user is enabled to enter any of a set of Chinese characters sufficient to enable typical communication to a Chinese reader. The method comprises associating groups of shape elements with respective non-numerically associated touch locations of the electronic device, and upon receipt of an indication that one or more of the touch locations have been invoked, constructing a Chinese character based on the shape elements associated with the invoked touch locations. The shape elements are a complete set of shape elements from which all Chinese characters in the set are formed. Every one of the shape elements belongs to one of the groups. All shape elements in each group resemble each other in shape.

In another aspect, the disclosure features a device that comprises a processor, memory coupled to the processor, and non-numerically associated touch locations. The memory stores a complete set of shape elements from which all Chinese characters in a set of Chinese characters that are sufficient to enable typical communication to a Chinese reader. The shape elements are organized in groups that are associated with respective non-numerically associated touch locations of the device. Every one of the shape elements belongs to one of the groups. All shape elements in each group resemble each other in shape. The processor is configured to upon receipt of an indication that one or more of the touch locations have been invoked, construct a Chinese character based on the shape elements of the database that are associated with the invoked touch locations. The constructed Chinese character is any of the set of Chinese characters sufficient to enable typical communication to a Chinese reader.

In another aspect, the disclosure features a computer program product tangibly stored on a computer readable storage device. The computer program product comprises instructions for causing a processor to: upon receipt of an indication that one or more of non-numerically associate touch locations have been invoked, access a database that stores a complete set of shape elements from which all Chinese characters in a set of Chinese characters that are sufficient to enable typical communication to a Chinese reader, and construct a Chinese character based on the shape elements of the database that are associated with the invoked touch locations. The shape elements are organized in groups that are associated with the respective non-numerical touch locations. Every one of the shape elements belongs to one of the groups. All shape elements in each group resemble each other in shape. The constructed Chinese character is any of the set of Chinese characters sufficient to enable typical communication to a Chinese reader.

Embodiments of the method, the device, and the computer program product may also include one or more of the following features. Each touch location is displayed to the user with a label having a shape, and wherein the shape of the label resembles at least some of the shape elements of a group of shape elements that is associated with the touch location. The labels of the touch locations comprise Roman letters or selected shape elements of the associated groups. The touch locations are part of a virtual key set. The touch locations are part of a physical keyboard. A Chinese character is constructed by requiring the user to invoke no more than three touch locations in a predetermined order. The no more than three touch locations are associated with no more than three shape elements, respectively, and the predetermined order corresponds to a sequence of writing the three shape elements in the Chinese character under standard rules of Chinese character writing. The no more than three shape elements comprise a first shape element that is written first in the Chinese character under the standard rules. The no more than three shape elements also comprise a second shape element that is written immediately after the first shape element in the Chinese character under the standard rules. The no more than three shape elements also comprise a third shape element that is written the last in the Chinese character under the standard rules. A Chinese character is constructed by constructing the Chinese character as a part of constructing a Chinese phrase containing two or more Chinese characters. The Chinese phrase comprises a first Chinese character and a second Chinese character after the first Chinese character. The Chinese phrase is constructed by requiring the user to invoke touch locations in a predetermined order that comprises a first shape element to be written first in the first Chinese character, a second shape element to be written immediately after the first shape element in the first Chinese character, a first shape element to be written first in the second Chinese character, and a second shape element to be written immediately after the first shape element in the second Chinese character. The Chinese phrase consists of two Chinese characters and the user is required to invoke no more than four touch locations. The Chinese phrase consists of three Chinese characters and the user is required to invoke no more than five touch locations. The Chinese phrase consists of four Chinese characters and the user is required to invoke no more than six touch locations. Multiple Chinese characters are constructed based on the indication that one or more of the touch locations are invoked, and the user is enabled to choose a desired Chinese character as input among the multiple Chinese characters. The touch locations can be virtual locations on a touch screen or physical keys of a keyboard. The database can be updated with additional Chinese characters or phrases in association with sequences of touch locations.

### DESCRIPTION OF DRAWINGS

FIGS. 1A, 1C, 1D, and 1E are examples of Chinese characters.

FIG. 1B shows a shape element of the Chinese character of FIG. 1A.

FIG. 2 is a block diagram showing an example of a device that implements the methods of the disclosure.

FIG. 3 shows an example of grouping of shape elements.

FIG. 4 shows an example of association of the grouped shape elements of FIG. 3 with keys of a QWERTY keyboard.

FIGS. 5A and 5B are schematic diagrams showing examples of user interfaces and keyboards for inputting Chinese characters or phrases.

FIGS. 6A and 6B are schematic diagrams showing examples of user interfaces on a touch screen for inputting Chinese characters or phrases.

FIGS. 7 and 8 are flow diagrams showing examples of processes performed by devices implementing the methods of this disclosure.

FIG. 9 is a schematic diagram showing an example of a user interface for a dictionary application.

FIG. 10 shows an example of a two-character Chinese phrase.

FIG. 11 is a block diagram showing an example of a computer system.

### DETAILED DESCRIPTION

Chinese characters can be entered into a digital device intuitively and parsimoniously without requiring long-time learning or memorization. For example, Chinese characters are decomposed into shape elements that are grouped into families based on the similarity of the shapes, making it easy for the user to remember which elements are in the grouping. Each grouping is assigned to a particular input keystroke, which can be an actual physical key on a keyboard, or a virtual button on a touchscreen. This can make the entry method highly flexible to accommodate a number of different hardware configurations. If the groupings are assigned to keys in a physical keyboard, the key is chosen so that the key identifier (e.g., the Roman letter or English letter) resembles the shape elements to make it more intuitive for the user and facilitates recall of which keystroke represents a particular grouping. On a virtual keyboard (which is available on touch screen devices such as mobile phones, tablets, and computers), each virtual key may be labeled with one or more representative elements of an associated grouping so that the user does not have to memorize the association and can select keystrokes for the shape elements by looking at the label of the key. The labels of the key can be shape elements of the groupings or other elements that succinctly convey the underlying shape element assignments by virtue of shape similarity for the user to readily identify the key for the groupings.

Chinese characters can be efficiently entered one character at a time, in two-character phrases, in three-character phrases, and in four-character phrases using a series of keystrokes containing a limited number of, e.g., less than four, keystrokes. Each series of keystrokes can identify a Chinese character or a phrase without much redundancy. In other words, for most of the Chinese characters and phrases, the series of the keystrokes is unique (while many Chinese characters and phrases can have the same pronunciation). The user entering the unique keystroke series can input the Chinese characters quickly without needing to select the desired Chinese characters from groups of redundant candidates.

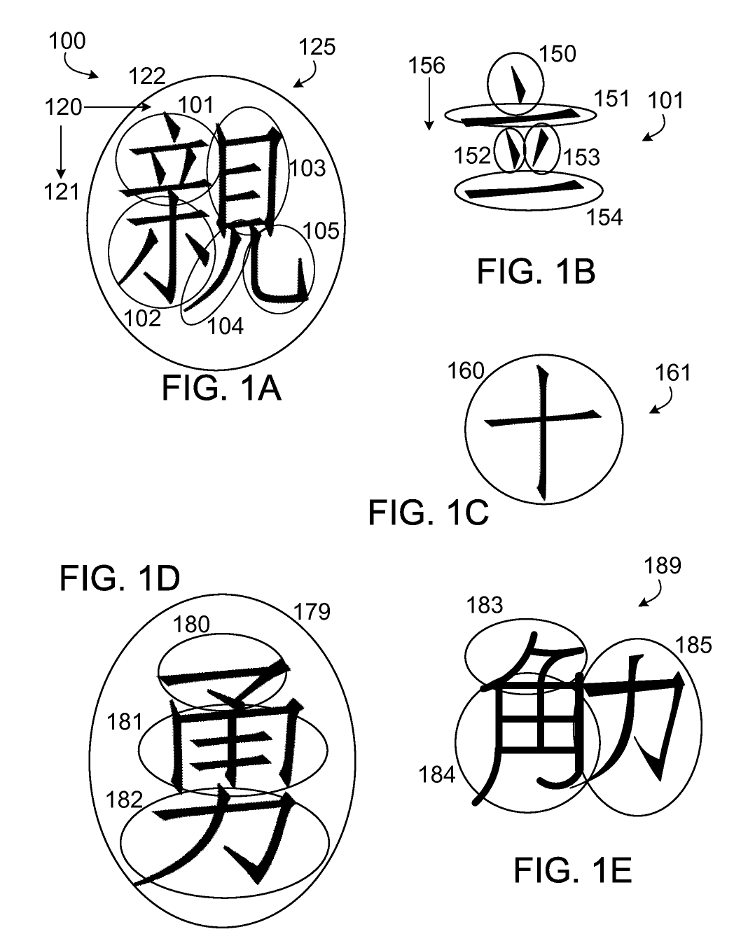

Referring to FIG. 1A and 1B, an example of a Chinese character is illustrated. The Chinese character 100 is decomposed into shape elements 101, 102, 103, 104, 105. Each shape element 101, 102, 103, 104, 105 is formed of a sequence of strokes. For example, as shown in FIG. 1B, the shape element 101 contains strokes 150 (an abbreviated “dot” stroke), 151 (horizontal to the right), 152 (downward to the right), 153 (downward to the left), 154 (horizontal to the right). In writing, generally, the strokes (e.g., the strokes 150-154) of each shape element (e.g., the shape element 101) and the shape elements are written in a particular order, e.g., from top to down and from left to right, to complete a Chinese character. In the example of the Chinese character 100, one starts writing from a top left corner 120 (i.e., the shape element 101), moves down along a direction 121 (i.e., the shape element 102), and then moves along the right direction 122 and starts with from the top right corner 125 (i.e., the shape element 103 and then the shape element 104). Within each shape element 101, 102, 103, 104, the order of writing the strokes generally follows the same order described for the order of the shape elements. For example, the shape element 101 of FIG. 1B is written from top to down along a direction 156 (i.e., first the stroke 150, and then the stroke 151, the stroke 152, and the stroke 153, and finally, the stroke 154).

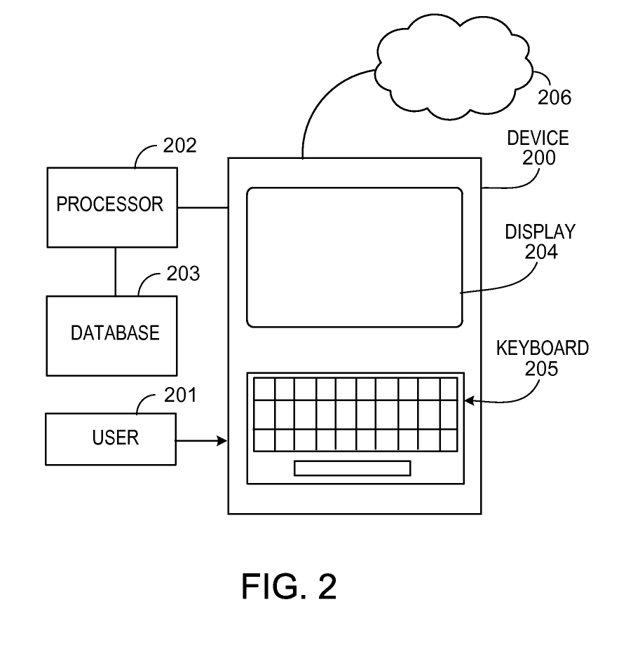

Referring to FIG. 2, a user 301 can readily input Chinese characters, like the Chinese character 100 of FIG. 1A, into an electronic device 200 using a keyboard 205. The electronic device can be a mobile device, e.g., a smart phone, a tablet, etc. or can be a computing device, such as a word processor on a computer. The keyboard 205 can be an integral part of the electronic device 200, e.g., a physical keyboard on a smart phone or a virtual keyboard on a tablet. The keyboard 205 can also be a separated from the electronic device, e.g., a stand-alone keyboard that connects to a computer. The keyboard 205 contains keys 208, some of which correspond to English letters A-Z. An example of the keyboard 205 is a QWERTY keyboard. However, other keyboard 205 containing English letters or any manner of labeling representative of shape element families can also be used for inputting the Chinese characters.

The input Chinese characters can be part of a text message, an email message, a document, etc. and can be displayed on a display 204 of the device 200. The device 304 can be connected to the Internet 206 or a mobile network, through which the input Chinese characters can be delivered to other devices.

The device 200 can include a processor 202 and storage devices such as memory that stores a database 203. The storage devices can also store software that is executed by the processor 202 to enable the user 201 to input Chinese characters using the keyboard 205. The software implements Chinese character input methods that correlate the strokes and/or shape elements with keys of the keyboard and that take into consideration the sequence of the writing of the shape elements.

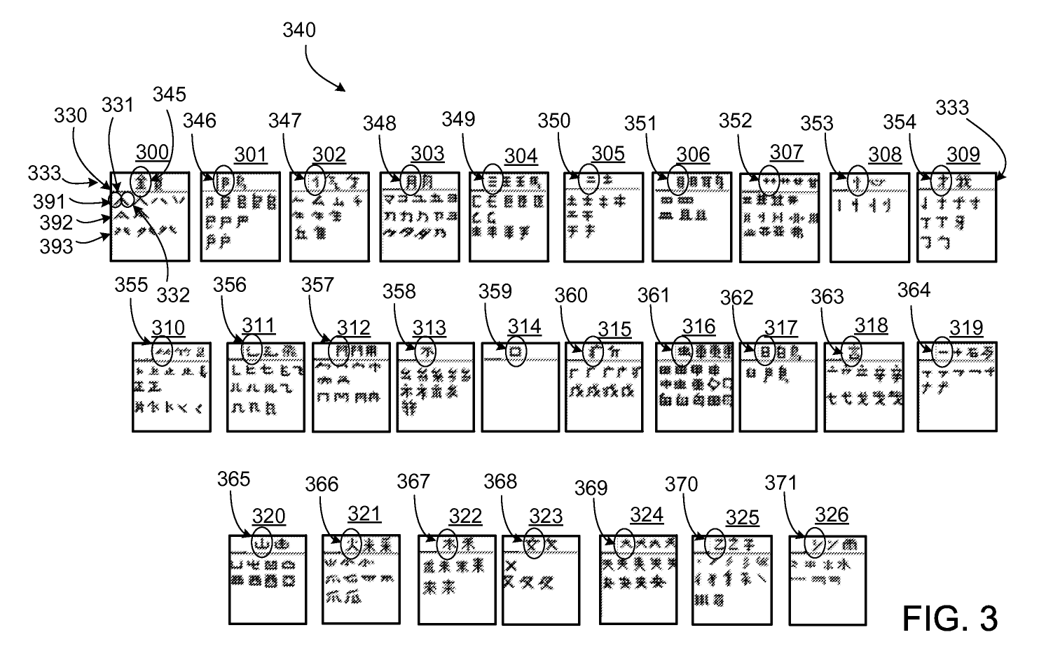

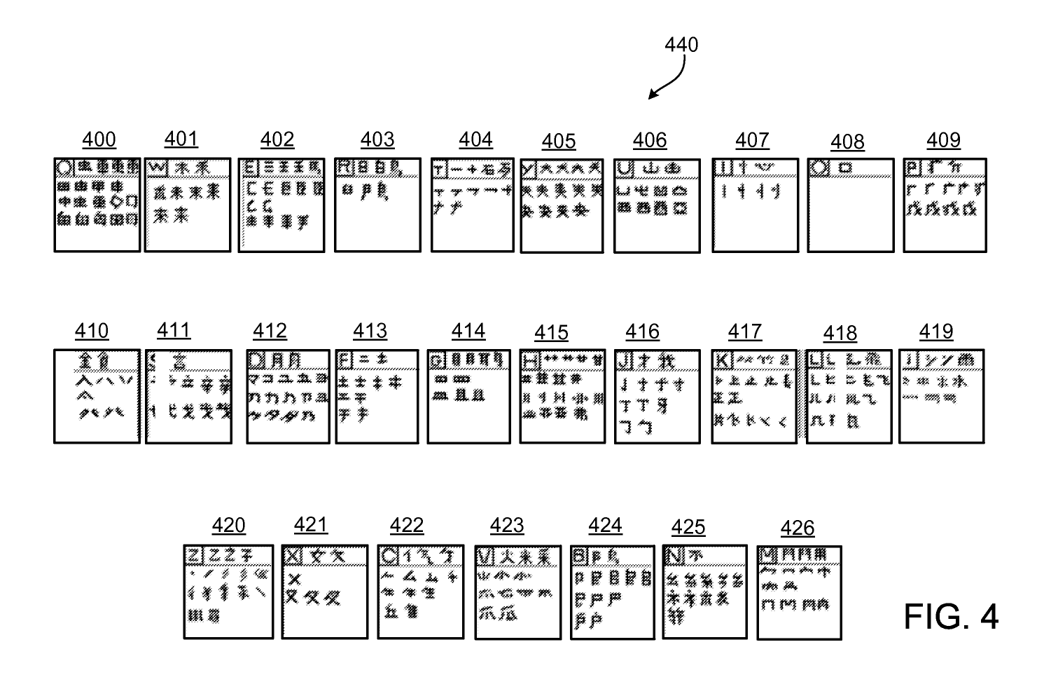

Referring to FIG. 3, shape elements that frequently appear in commonly used Chinese characters, e.g., about 5,000 Chinese characters or more that are sufficient to enable typical communication to a Chinese reader, are grouped into 27 groups 300-326. The shape elements are grouped according to their graphical similarities. For example, in the group 300, all shape elements have a peak shape formed by a downward left stroke 330 and downward right stroke 331 that meet near or at the middle 332. Details of the features of the groups 300-326 are summarized in Table 1 below. The shape elements in the same group can form subgroups that are displayed in rows. The shape elements in each subgroup have similar characteristics, e.g., have more similarities than those shape elements in different subgroups in the same group. For example, although all shape elements in three rows 391, 392, 392 of the group 300 contain the downward left stroke 330 and the downward right stroke 331, the shape elements in the row 392 contain one additional stroke under the strokes 330, 331, the shape elements in the row 293 contain additional strokes above the strokes 330, 331, while the shape elements in the row 291 do not contain strokes in addition to the strokes 330, 331. The formation of the subgroups can help the user more easily remember the shape element groupings. In each group 300-326, the shape elements that are most frequently used are listed in a top row 333, from which a user referring to the grouping shown in FIG. 3 can find the most frequently used shape elements quickly.

The groups 300-326 and the subgroup rows (including the top row) in each group can be arranged differently. For example, the groups 300-326 can be provided to a user (e.g., the user 201 of FIG. 2) in the form of a grouping table 340 of FIG. 3 or the grouping table 440 of FIG. 4 (discussed in detail below) to facilitate the user with inputting Chinese characters. Grouping the shape elements based on graphical similarities can reduce the amount of memorization the user has to use for learning the method of inputting the Chinese characters. In some implementations, additional shape elements can be added to the existing groups based on the shape of the additional shape elements to expand the number of Chinese characters the existing groups of shape elements allow a user to input. In some implementations, the method is a smart method that learns from a user's mistakes. For example, when the method or system detects that a user intends to input a shape element in the group 300, but repeatedly (over a threshold number of times) makes mistakes by selecting the group 302, the method or system can automatically infer the user's intended group selection, or allow a user to permanently move a particular shape element from one group to another group. Different users may customize their methods or systems differently. In some implementations, common mistakes can be reported and the methods and systems can be updated for future users.

Referring to FIGS. 2 and 3, the groups 300-326 are correlated to the keys 208 of the keyboard 205. For example, each group 300-326 is associated with one distinct key, e.g., a virtual button on a touch screen digital device such as an iPad. In some implementations, each group 300-326 is associated with a distinct letter key, e.g., on a QWERTY keyboard (physical or virtual). The association and the groups are stored in the database 203 of the device 200. As explained previously, the database 203 can be updated when the grouping of the shape elements are updated, e.g., based on use.

In the example shown in FIG. 4, each group 400-426 of shape elements is associated with one of the letter keys A-Z 430a-430z and an additional key which corresponds to the “;” key (corresponding to group 419), such that the common shape of the group of shape elements resembles the shape of the associated letter. (The groups 400-426 are the same as the groups 300-326 of FIG. 3, except that the groups 400-426 are arranged in a different sequence.) For example, the group 410 (corresponding to the group 300 of FIG. 3) has a common peak shape, while the letter A also contains a peak shape and visually look similar to some of the shape elements in the group 410. The shape-based assignment of the groups to the letter keys can allow a user to memorize the assignment easily.

The characteristics of the shape element groups (as shown in FIGS. 3 and 4) and their respective association with the keys of a QWERT keyboard (as shown in FIG. 4) are described in Table 1.

TABLE 1
Common features of shape element in different groups.

| Group number | |
|---|---|
| and the | |
| associated key | Common features of the shape elements in the group |
| 300, 410, “A” | A peak shape formed by a downward left |
| | stroke 330 and downward right stroke |
| | 331 that meet near or at the middle 332. |
| | Some of the shape elements resemble |
| | the letter “A”. |
| 301, 424, “B” | A vertical line on the left and one or |
| | two boxes attached to the vertical line. |
| | Some of the shape elements resemble |
| | the letter “B”. |
| 302, 422, “C” | A downward diagonal line to the left |
| | connected with horizontal strokes. |
| | Some of the shape elements resemble |
| | the letter “C”. |
| 303, 412, “D” | A two-part stroke that goes horizontally |
| | to the right then down, resembling the |
| | numeral “7”, with or without a |
| | downward vertical stroke to the left of |
| | the two-part stroke. Some shape elements |
| | look like the letter “D”. |
| 304, 402, “E” | Multiple horizontal strokes that make the |
| | shape elements resemble the letter “E”. |
| 305, 413, “F” | Two horizontal strokes. Some of the shape |
| | elements resemble the letter “F”. |
| 306, 414, “G” | Boxes stacked vertically or horizontally. |
| 307, 415, “H” | Two or more vertical lines, with or without |
| | one or more horizontal lines that cuts across |
| | the vertical lines, making the shape element |
| | resemble the letter “H”. |
| 308, 407, “I” | A vertical line, resembling the letter “I” |
| | or a horizontal curve that looks |
| | like a curved, rotated “I”. |
| 309, 416, “J” | A vertical line with a hook to the left at |
| | the bottom, resembling the letter “J”. |
| 310, 417, “K” | A vertical or diagonal line and a horizontal |
| | line extending from the middle of the vertical |
| | or diagonal line to the right, |
| | resembling the letter “K”. |
| 311, 418, “L” | A vertical line and a horizontal line extending |
| | from the bottom of the vertical line to the |
| | right, resembling the letter “L”. |
| 312, 426, “M” | The shape elements contain two parallel vertical |
| | lines with one or more horizontal lines between |
| | the vertical lines. Some shape |
| | elements resemble the letter “M”. |
| 313, 425, “N” | Two diagonal downwards to the right strokes, |
| | or two diagonal strokes going in opposite |
| | directions. Parts of the shape elements |
| | resemble a rotated letter “N”. |
| 314, 408, “O” | A box that resembles the letter “O”. |
| 315, 409, “P” | A vertical line and a horizontal line extending |
| | from the top of the vertical line to the right, |
| | resembling a part of the letter “P”. |
| 316, 400, “Q” | A box with a short line extending out from the box |
| | at the top or the bottom of the box. Some shape |
| | elements resemble the letter “Q” or |
| | an upside-down letter “Q”. |
| 317, 403, “R” | Two parallel vertical lines with at most three |
| | horizontal lines between the two vertical lines. |
| | Parts of the shape elements |
| | resemble the letter “R”. |
| 318, 411, “S” | A dash at the top and a horizontal line under the dash. |
| 319, 404, “T” | A horizontal line at the top and a vertical |
| | line that connects to or cuts through the |
| | horizontal line. Some shape elements |
| | resemble the letter “T”. |
| 320, 406, “U” | Two parallel vertical lines that are connected |
| | at the bottom by a horizontal line, |
| | resembling the letter “U”. |
| 321, 423, “V” | Two diagonal lines going in opposite directions, |
| | with the diagonal lines extending from a meeting |
| | point downwards to the left and right, or |
| | upwards to the left and right. Some shape |
| | elements resemble the letter “V”. |
| 322, 401, “W” | A horizontal line at the top, a vertical line |
| | intersects the horizontal line, and two |
| | diagonal lines extend from the intersection of the |
| | horizontal and vertical lines downwards to |
| | the left and right. Some shape elements |
| | resemble a rotated letter “W”. |
| 323, 421, “X” | Two diagonal lines that cross, |
| | forming an “X” shape. |
| 324, 405, “Y” | A vertical line, the bottom of which is |
| | connected to two diagonal lines extending |
| | downwards to the left and right. Some |
| | shape elements resemble an |
| | upside-down letter “Y”. |
| 325, 420, “Z” | There are three subgroups. The first subgroup |
| | contains shape elements that look like the |
| | letter “Z”. The second subgroup contains |
| | shape elements with one or more parallel diagonal |
| | lines. The third element contains shape elements |
| | with parallel vertical lines and several horizontal |
| | lines extending from the middle of the vertical lines. |
| 326, 419, “;” | Multiple dots. Some of the shape elements |
| (semicolon) | resemble the semicolon symbol, “;”. |

In some implementations, when the device 200 is operating in the mode for Chinese character input, the grouping of the shape elements, such as the table 340 of FIG. 3, can appear on a touch screen of the device 200, without associating the groups 300-326 to keys. Each group 300-326 becomes a button that can be activated. A user can look at the groups 300-326 and take time to search for the shape elements he/she intends to input. The user does not have to memorize the grouping or the key association with the groups. The groups 300-326 can be arranged in any format, e.g., table format, lines, columns, circles, or sections that appear on the touch screen simultaneously or at different times. In some implementations, the user can be allowed to arrange the groups according to the user's own preference.

In some implementations, each group 300-326 can be represented by a symbol, e.g., one of the shape elements in each group, and the symbol may appear when the Chinese character input mode is activated. For example, the shape elements 345-371 could be used, respectively, to represent the groups 300-326.

The discussion below uses the key assignment of the groups shown in FIG. 4 as an example. In use, the user can turn the device 200 into the mode of Chinese character input. In this mode, each time a key that is associated with a group of shape elements is activated, the device 200 recognizes that the associated group shape elements is selected, instead of the English letter of the key. The user enters a Chinese character following the sequence of how the character is physically written. For example, the user activates a key containing the first shape element of the Chinese character he/she intends to enter, then chooses a key for the second shape element, and so on. When a series of keys has been activated followed by activating a designated key that indicates the entry is complete, e.g., a “space” key or any key that is not associated with any group of shape elements or a period of time has passed without receiving further activations, shape elements of different groups that correspond to the series of activated keys are combined and arranged based on the sequence of the key activations and the sequence of Chinese writing (i.e., generally from top to down and from left to right). The combinations and arrangements may produce one or more Chinese characters, which can be displayed to the user on the display 204 of the device. When multiple Chinese characters (candidates) are displayed, the user can choose the intended character by, e.g., clicking on the intended character, entering a numerical number, or other ways.

Chinese characters and phrases can be input into a digital device efficiently with a limited number of keystrokes using the shape element grouping and shape element-key association discussed above. Each single Chinese character can be entered using at most three keystrokes that represent three of the shape elements contained in the character. In particular, the three keystrokes represent the first shape element, the second shape element, and the last shape element of the character in the sequence of writing the shape elements of the character.

Chinese phrases containing two or more Chinese characters can be efficiently entered without requiring a user to enter all (three or fewer) keystrokes or shape elements required for each character. Instead, selected (less than all) keystrokes or shape elements of the characters can be concatenated into a string of keystrokes for inputting the Chinese phrases containing the characters. Generally, the string of keystrokes includes keys corresponding to the first two shape elements of the first two Chinese characters in the phrase. If the phrase includes three or more characters, the string of keystrokes includes additional keys corresponding to the first shape element of each additional character.

For example, four or fewer keystrokes can be used to input a two-character phrase. The first two keystrokes enter the first two shape elements of the first character in the two-character phrase, and the next keystrokes correspond to the first two shape elements of the second character. To enter a three-character phrase, five or fewer keystrokes can be used, which correspond to the first two shape elements of the first character, the first two shape elements of the second character, and the first shape element of the third character. Six or fewer keystrokes can be used to input a four-character phrase, which correspond to the first two shape elements of the first character, the first two shape elements of the second character, the first shape element of the third character, and the first shape element of the fourth character. To enter a five-character phrase, six or fewer keystrokes are needed, which correspond to the first two shape elements of the first character, the first two shape elements of the second character, the first shape element of the third character, the first shape element of the fourth character, and the first shape element from the fifth character.

The combination of the strokes (three or fewer for the single character, four or fewer for the two-character phrase, five or fewer for the three-character phrase, dix or fewer for the four or five-character phrase) can produce unique characters or phrases so that the characters or phrases can be entered without requiring the user to further select from lists of candidates. When occasionally there are multiple candidates corresponding to the series of input keystrokes, the number of candidates is typically small, e.g., less than four. The grouping of the shape elements, the selection of the shape elements to represent the characters (single or in phrases), and the features of the Chinese characters and phrases allows efficient input, so that user selection at the end of the input process amongst multiple candidate characters or phrases is rarely necessary.

As an example, referring again to FIGS. 1A and 2-4, 5A and 5B, the shape elements 101-105 are in the groups 318, 322, 306, 325 and 311. Using the assignment of the groups and letter keys discussed with respect to FIG. 4, a user first activates the letter key “S” that corresponds to the group 411 that contains the shape element 101 (first element in writing). The user then activates the letter key “W” that corresponds to the group 401 that contains the shape element 102 (second element in writing). The user then activates the letter key “L” that corresponds to the group 418 that contains the shape element 105 (last element in writing). The user then activates the “space key” or some other key to indicate the end of the character.

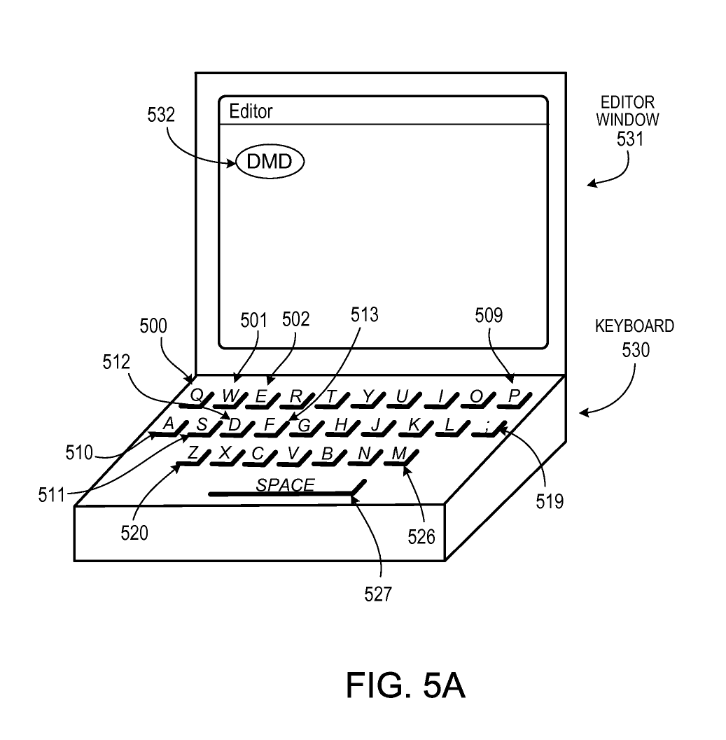

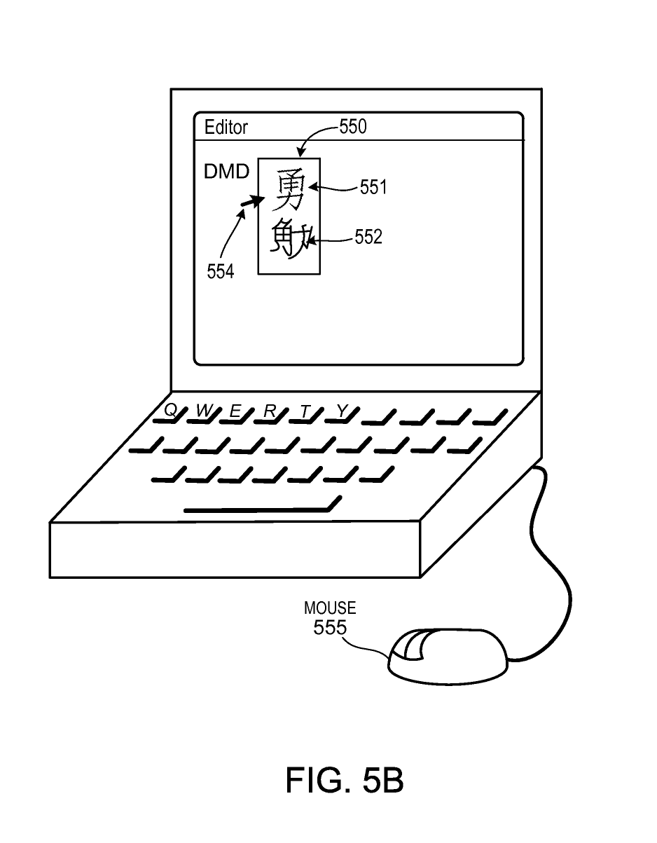

If there is more than one Chinese character that corresponds to the given sequence of buttons, then all the applicable characters (or candidates) will be displayed so that the user can choose the desired character. For example, a three-key sequence, “D” (412), “M” (426), “D” (412) represents two different Chinese characters 179, 189 illustrated in FIGS. 1D and 1E. The shape elements 180, 181, and 182 for the Chinese characters are in groups 412, 426, and 412, respectively and should be entered in the sequence of DMD; the shape elements 183, 184, and 185 are also in groups 412, 426, and 412 respectively and should also be entered in the sequence of DMD. In the example shown in FIGS. 5A-5B, when a user enters the three-key sequence “DMD” (keys 512, 526, 512) in the keyboard 530, the letter sequence “DMD” 532 appears in the editor window 531. When the user presses the space key 527, a drop-down menu 550 displays the Chinese characters 551, 552 (corresponding to the characters 179, 189 of FIGS. 1D-1E) that match the “DMD” sequence. The user can select the desired character using a mouse 555 to control a cursor 554. Other forms of display or selection can also be used.

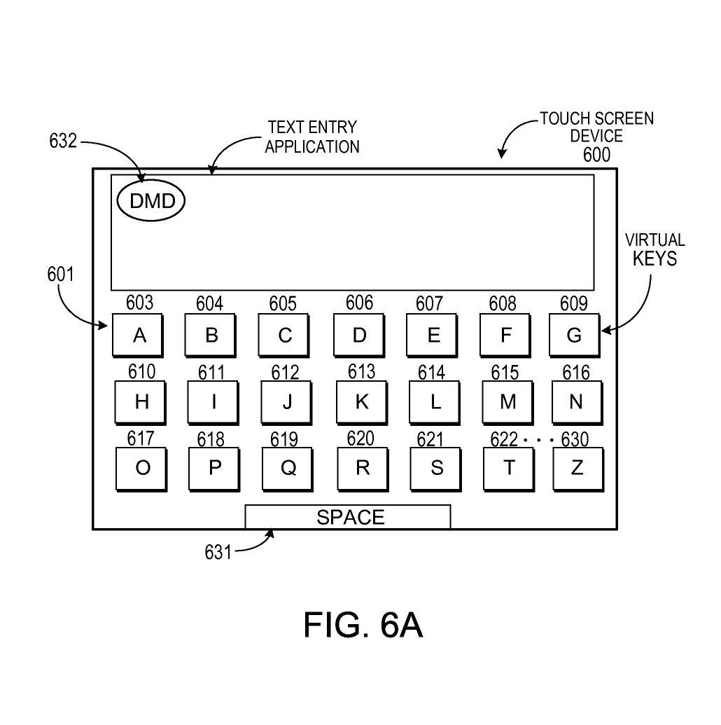

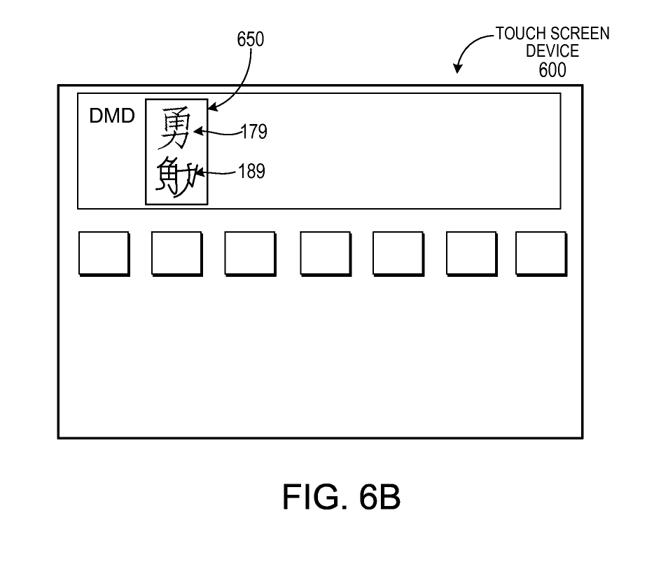

Alternative to a physical keyboard, referring to FIG. 6A, a user can also enter the Chinese character 179 (FIG. 1D) through a text entry application on a touch screen digital device 600. The keys 603, 604, 605, . . . , 630 can be arranged on the touch screen 601 in any order or form and can be labeled with English letters, shape elements, or others. In the example shown in FIG. 6A, the virtual keys are labeled with English letters. Based on the grouping shown in FIGS. 3 and 4, the user activates a virtual key 606 (corresponding to the letter “D”) for the first shape element of the character 179, followed by a virtual key 615 (corresponding to the letter “M”) for the second shape element, then a virtual key 606 (corresponding to the letter “D”) for the last shape element, and finally the virtual space key 631. The letters “D”, “M”, “D” can appear 632 on an upper portion 632 of the touch screen 601 simultaneous to the user's activation of the respective virtual keys. When the space key is pressed (FIG. 6B), a drop-down menu 650 with all the Chinese characters that match the “DMD” sequence is displayed. The user selects the desired character by pressing on the screen at the location of the character, e.g., using a stylus or his/her finger(s).

In some cases, a Chinese character can be represented by only one or two shape elements. To enter the Chinese character, only one or two keys are used, followed by the “space key”. For example, the Chinese character 161 illustrated in FIG. 1C contains a single shape element 160, which is grouped in the group 404 of FIG. 4 and is associated with the letter key “T”. The Chinese character 161 can be entered by activating the key “T” followed by the “space” key.

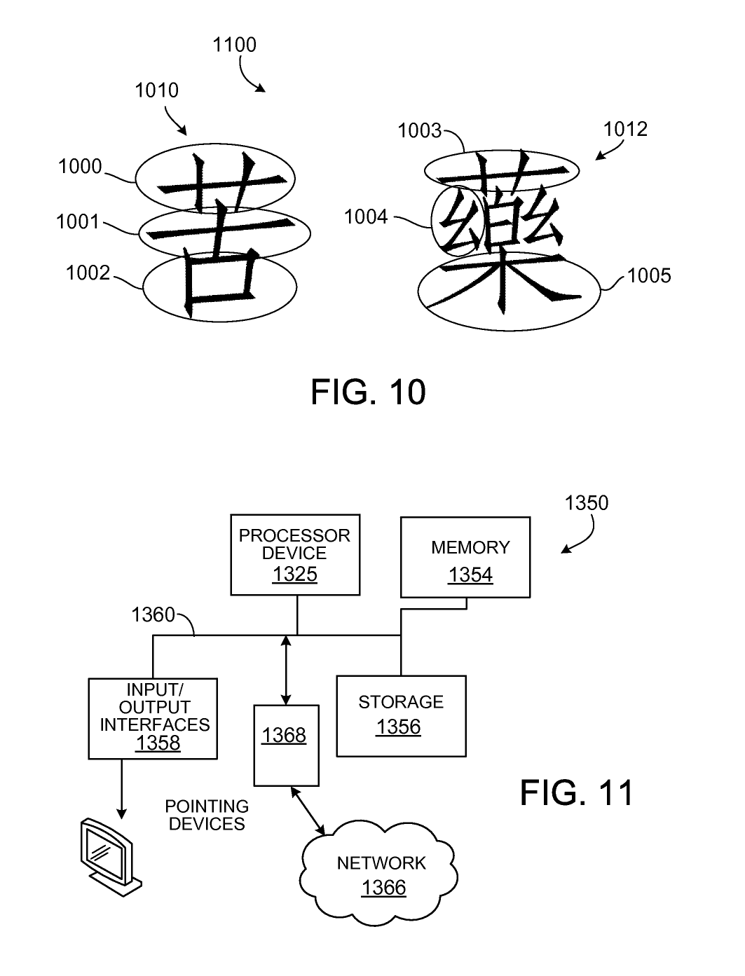

An example of inputting a two-character Chinese phrase 1100 shown in FIG. 10 is as follows. The phrase 1100 includes two characters 1010 and 1012 and is a commonly used phrase that means “bitter medicine”. Referring also to FIG. 4, the three-key sequence that represents the shape elements 1000, 1001, 1002 of the first Chinese character 1010 is “HTO”, corresponding to the groups 415, 404, and 408. The three-key sequence that represents the shape elements 1003, 1004, 1005 of the second Chinese character in FIG. 10B is “HNW”, corresponding to the groups 415, 425, and 401. To enter the two-character phrase 1100, a user activates the keys in “HTHN” corresponding to groups 415, 404, 415, and 425, followed by the space key. This phrase input method saves two key strokes over individually entering each character 1010, 1012 (three keystrokes for each individual character). If a character only requires fewer than three shape elements in its representation, a padding key that is not associated with any group can be used to represent the missing shape element(s) in the phrase input.

Similarly, entering a three-character Chinese phrase by concatenating the first two shape elements of the first character, the first two shape elements of the second character, and the first shape element of the third character can save four key strokes over individually entering three characters of the phrase; entering a four-character Chinese phrase by concatenating the first two shape elements of the first character, the first two shape elements of the second character, the first shape element of the third character, and the first shape element of the fourth character uses a six-key sequence, and can save six keystrokes over individually entering each of the four characters; Entering a five-character Chinese phrase by concatenating the first two shape elements of the first character, the first two shape elements of the second character, the first shape element of the third character, the first shape element of the fourth character, and the first shape element of the fifth character uses a seven-key sequence and can save eight key strokes over individually entering each character of the five characters.

In some implementations, the candidates of Chinese characters can appear on the display before the entire series of keys are activated for a desired input. The user can choose to continue to input the keystrokes to reduce the number of candidates or to finish the entire series of keystrokes until the desired input is displayed, or can select the desired input from the displayed candidates. For example, when a first key stroke is activated, a list of candidates is displayed. The list may be long and the desired input may be at the end of the list that requires the user to flip pages of display to find the desired input. The user can look for and select the desired input. Alternatively, the user can continue with the series of keystrokes to reduce the number of candidates or finish the series of keystrokes to enter the desired input. The display of candidates can help users, particularly those who are not familiar with the all associations of the shape elements and the keys, to input Chinese characters or phrases. The system can be configured to recognize the completion of inputting a series of key strokes when a space key or other unmapped keys are activated after the mapped keys are activated, or when a predetermined amount of time lapses without further activation. The system enters the Chinese characters or phrases when the user actively selects the characters or phrases, or the system identifies the activation as complete.

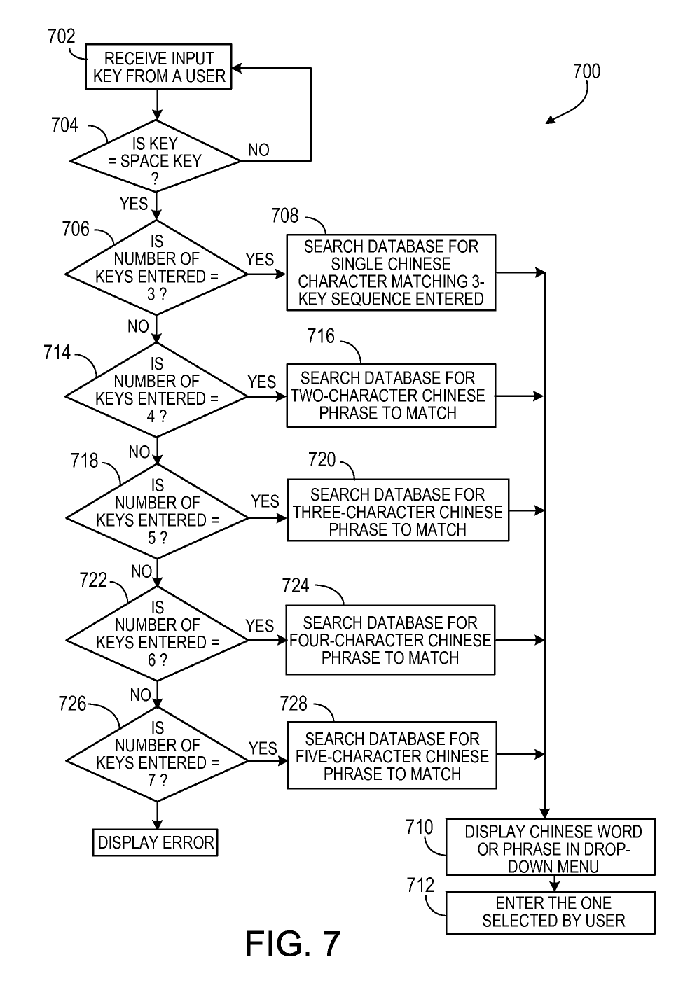

FIG. 7 shows an example of a process 700 in which a device implementing the method of this disclosure (such as the device 200 of FIG. 2) outputs Chinese characters upon receiving a user's input. Each character can be entered individually (one at a time), or as part of a phrase. In the Chinese input mode, a processor of the device receives 702 input key from a user and determines 704 whether the input key corresponds to the “space” key. If not, the processor will continue to receive additional input keys. Receipt of the “space” key allows the processor to determine that the user has finished entering a single character or a multi-character phrase. The processor counts the number of keystrokes received before the “space” key. If the number of keystrokes is determined 706 to be three, then the processor searches 708 in a database for all single characters that are represented by the three-key sequence entered and displays 710 all the found characters. Optionally, when there are more than one characters displayed, the processor enters 712 the character selected by the user. If the number of keystrokes is determined 714 to be four, then the processor searches 716 in the database for all two-character phrases that match the four-key sequence entered and displays 710 all the found two-character phrases. If the number of keystrokes is determined 718 to be five, then the processor searches 720 in the database for all three-character phrases that match the five keys entered and displays 710 all the three-character phrases that match. If the number of keystrokes is determined 722 to be six, then the processor searches in a database for all four-character phrases that match the six keys entered and displays 724 all the four-character phrases that match. If the number of keystrokes is determined 726 to be seven, then the processor searches 728 in the database for all five-character phrases that match the seven keys entered and displays 710 all the five-character phrases that match. If the number of keystrokes entered is higher than seven, the processor returns 730 an error and prompts the user to re-enter the keys.

Modifications can be made to the process 700. For example, some Chinese characters may be entered using less than three keys. In another example, the device can allow the user to enter more than one character or phrase at a time, e.g., an entire sentence continuously without any space key. As discussed previously, sometimes the device can simultaneously display candidates with the user's key entry before the space key.

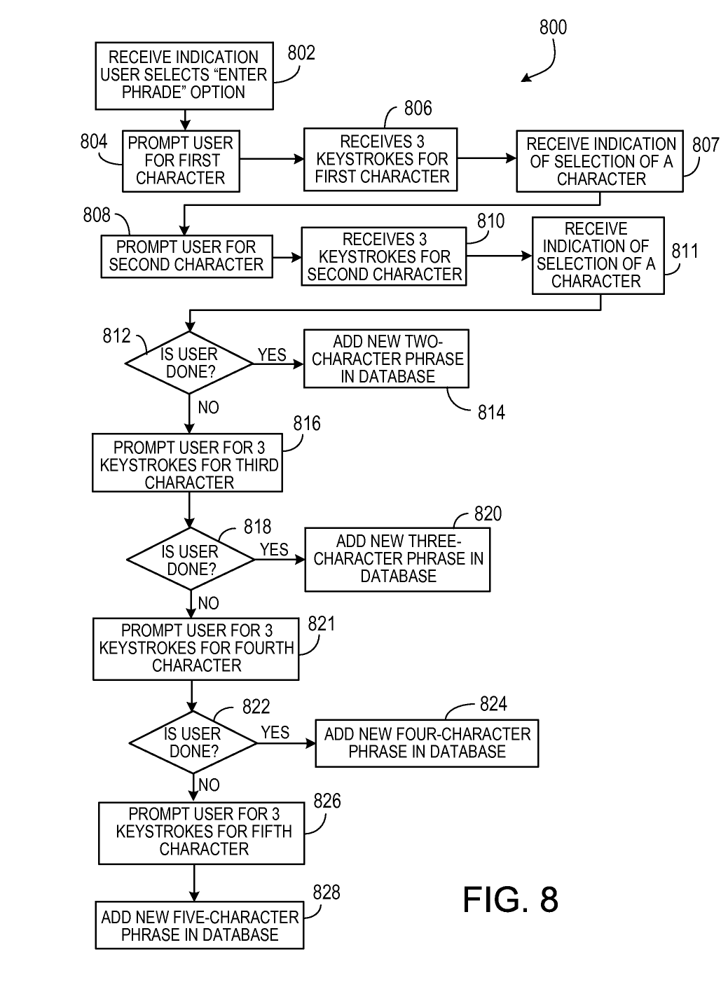

In some implementations, the device can update its database with new phrases, e.g., automatically based on the user's frequent usage of the phrases or by allowing the user to enter a mode (the “enter phrase”) to manually enter the new phrases into the database. Referring to FIG. 8, an example of a process 800 in which a user updates the database manually. The processor of the device receives 802 an indication that the user has selected the “enter phrase” option to enter his/her own phases into the database. The processor then prompts 804 (e.g., on a display or screen) the user to enter the first character of a phrase and receives 806 three (or fewer) keystrokes representing the first character. After the processor retrieves and displays all characters that match the entered keystrokes to the user, e.g., using drop down menu 550 of FIG. 5B, the processor receives 807 an indication that the user selects a desired character. The processor then prompts 808 the user to enter the next character in the phrase to be added. The processor receives 810 three keystrokes representing the second character. After the processor retrieves and displays all characters that match the entered keys, the processor receives an indication that the user selects a desired character. The processor then provides 812 the user with the choice to continue adding another character or to add the phrase having the two entered characters. If the user chooses to add the phrase, the processor stores 814 the new two-character phrase in the database. If the user chooses to continue, the processor prompts 816 the user to enter a third character for the phase to be added. The processor enters the third character in a manner similarly to those of steps 806, 807 or steps 810, 811 discussed previously. After that, the processor provides 818 the user with the choice to continue adding another or to add the three-character phrase. If the user chooses to add the phrase, the processor stores 820 the new three-character phrase in the database. If the user chooses to continue, the processor prompts 821 the user to enter a fourth character for the phrase to be added. Again, similar to the first three characters, the processor enters the fourth desired character. The processor then provides 822 the user with the choice to continue adding another or to add the four-character phrase into the database. If the user chooses to add the phrase, the processor stores 824 the four-character phrase in the database. If the user chooses to continue, the processor prompts 826 the user to enter a fifth character for the phrase to be entered and enters the fifth character in a similar manner to those discussed for the previous four characters. The processor then stores 828 the five-character phrase in the database. In some implementations, the process 800 can be extended to allow the user to add phrases containing six or more characters.

In some situations, when the user is connected to a server storing the central database for the Chinese character input methods or devices of other users, the server can be updated with the newly added phrases and can push the update to the database of devices of the other users.

In some implementations, the processes, methods, and systems can be integrated with a Chinese-English dictionary application. The dictionary can be an electronic online dictionary or local to (downloaded and stored on) an electronic device. Software and database implementing the Chinese input methods of this disclosure can also be downloaded the user's device or reside on a server that provides the dictionary application. The methods of this disclosure can allow a user who is not very familiar with the Chinese language (e.g., meaning and pronunciation) to look up the meaning and pronunciation of Chinese characters or phrases.

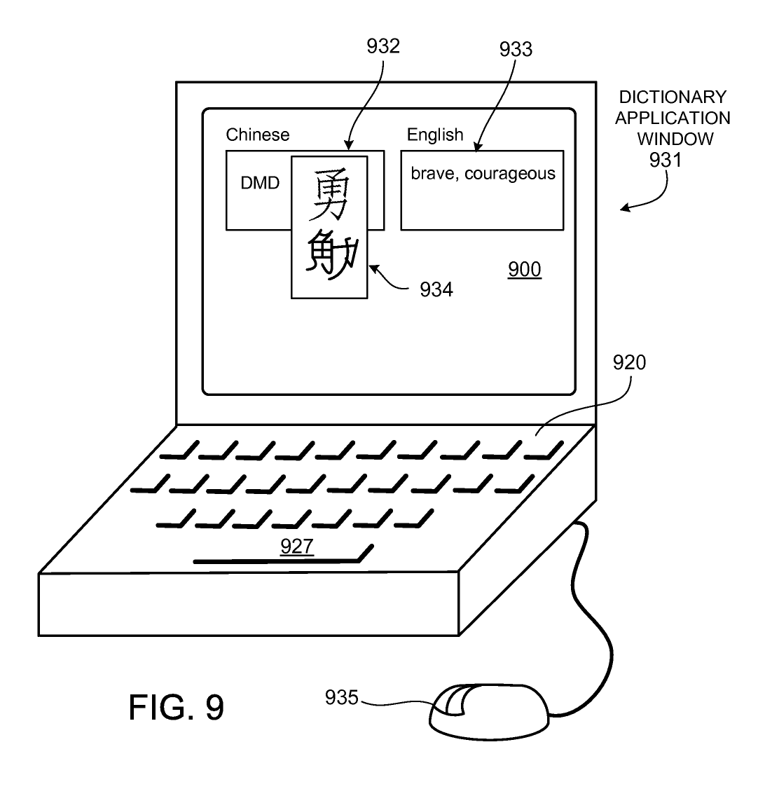

On a user interface 900 of FIG. 9 that implements the dictionary application, a user can input Chinese characters/phrases in a window 932 to look up the meaning of the character, which is displayed in the window 933. For the purpose of discussion, we use the character 179 of FIG. 1D as an example. The user enters the keys “D”, “M”, and “D” using a keyboard 920, followed by a “space” key 927. A drop-down menu 934 shows two Chinese characters that match the key series “DMD”. The user selects the character 179 using a mouse 935. The English meaning of the selected character is displayed in the text box 933. A multi-character phrase can also be entered in 932 and its meaning will be displayed in 933. In some implementations, the pronunciation of the entered characters or phrases is also shown. Other typical dictionary contents, such as sample use, can also be displayed.

To use the Chinese character input methods of this disclosure, the user can download the software for use on his/her personal device, or can access, e.g., through Internet or other networks, a website that incorporate the methods in its software. The methods are machine-based, e.g., established on processors. Computer programs can be stored and executed by a machine to perform the methods.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

FIG. 11 is a schematic diagram of an example computer system 1350. The system 1350 can be used for implementing the Chinese input methods discussed above. The system 1350 can include a processor device 1325, a memory 1354, a storage device 1356, and input/output interfaces 1358 interconnected via a bus 1360. The processor 1352 is capable of processing instructions within the system 1350. These instructions can implement one or more aspects of the systems, components and techniques described above. In some implementations, the processor 1352 is a single-threaded processor. In other implementations, the processor 1352 is a multi-threaded processor. The processor 1352 can include multiple processing cores and is capable of processing instructions stored in the memory 1354 or on the storage device 1354 to display graphical information for a user interface on output monitor device 1362.

The computer system 1350 can be connected to a network 1366, e.g., the Internet, through a network interface controller 1368. The memory 1354 is a computer readable medium such as volatile or non-volatile that stores information within the system 1350. The storage device 1356 is capable of providing persistent storage for the system 1350. The storage device 1356 can include a floppy disk device, a hard disk device, an optical disk device, or a tape device, or other suitable persistent storage mediums. The storage device 1356 can store the various databases described above. The input/output device 1358 provides input/output operations for the system 1350. The input/output device 1358 can include a keyboard, a pointing device, and a display unit for displaying graphical user interfaces.

The computer system can be implemented in a computer, a hand-held device, a tablet, a cell phone, etc.

An exemplary view of a computer system is shown in FIG. 11, and is but one example. In general, embodiments of the subject matter and the functional operations described in this specification can be implemented in digital electronic circuitry, or in computer software, firmware, or hardware. Embodiments of the subject matter described in this specification can be implemented as one or more computer program products, i.e., one or more modules of computer program instructions encoded on a computer readable medium for execution by, or to control the operation of, data processing apparatus. The computer readable medium is a machine-readable storage device. The invention can be embodied in and/or or used with various apparatus, devices, and machines for processing data, including by way of example a programmable processor, a computer, or multiple processors or computers.

What is claimed is:

1. A method for use in causing Chinese characters that comprise shape elements to be constructed by an electronic device, the method comprising:
a user being enabled to enter any of a set of Chinese characters sufficient to enable typical communication to a Chinese reader,
associating groups of shape elements with respective non-numerically associated touch locations of the electronic device, the shape elements being a complete set of shape elements from which all Chinese characters in the set are formed, every one of the shape elements belonging to one of the groups, and all shape elements in each group resembling each other in shape, and
upon receipt of an indication that one or more of the touch locations have been invoked, constructing a Chinese character based on the shape elements associated with the invoked touch locations.

2. The method of claim 1, wherein each touch location is displayed to the user with a label having a shape, and wherein the shape of the label resembles at least some of the shape elements of a group of shape elements that is associated with the touch location.

3. The method of claim 2, wherein the labels of the touch locations comprise Roman letters or selected shape elements of the associated groups.

4. The method of claim 1, wherein the touch locations are part of a virtual key set.

5. The method of claim 1, wherein the touch locations are part of a physical keyboard.

6. The method of claim 1, wherein constructing a Chinese character comprises requiring the user to invoke no more than three touch locations in a predetermined order.

7. The method of claim 6, wherein the no more than three touch locations are associated with no more than three shape elements, respectively, and the predetermined order corresponds to a sequence of writing the three shape elements in the Chinese character under standard rules of Chinese character writing.

8. The method of claim 7, wherein the no more than three shape elements comprise a first shape element that is written first in the Chinese character under the standard rules.

9. The method of claim 8, wherein the no more than three shape elements also comprise a second shape element that is written immediately after the first shape element in the Chinese character under the standard rules.

10. The method of claim 9, wherein the no more than three shape elements also comprise a third shape element that is written the last in the Chinese character under the standard rules.

11. The method of claim 1, wherein constructing a Chinese character comprises constructing the Chinese character as a part of constructing a Chinese phrase containing two or more Chinese characters,
wherein the Chinese phrase comprises a first Chinese character and a second Chinese character after the first Chinese character, and
wherein constructing a Chinese phrase comprises requiring the user to invoke touch locations in a predetermined order,
the touch locations in the predetermined order comprising a first shape element to be written first in the first Chinese character, a second shape element to be written immediately after the first shape element in the first Chinese character, a first shape element to be written first in the second Chinese character, and a second shape element to be written immediately after the first shape element in the second Chinese character.

12. The method of claim 11, wherein the Chinese phrase consists of two Chinese characters and the user is required to invoke no more than four touch locations.

13. The method of claim 11, wherein the Chinese phrase consists of three Chinese characters and the user is required to invoke no more than five touch locations.

14. The method of claim 11, wherein the Chinese phrase consists of four Chinese characters and the user is required to invoke no more than six touch locations.

15. The method of claim 1, comprising constructing multiple Chinese characters based on the indication that one or more of the touch locations are invoked, and enabling the user to choose a desired Chinese character as input among the multiple Chinese characters.

16. A device comprising:
a processor;
memory coupled to the processor; and
non-numerically associated touch locations,
the memory storing a complete set of shape elements from which all Chinese characters in a set of Chinese characters that are sufficient to enable typical communication to a Chinese reader, the shape elements being organized in groups that are associated with respective non-numerically associated touch locations of the device, every one of the shape elements belonging to one of the groups, all shape elements in each group resembling each other in shape,
the processor being configured to:
upon receipt of an indication that one or more of the touch locations have been invoked, construct a Chinese character based on the shape elements of the database that are associated with the invoked touch locations, the constructed Chinese character being any of the set of Chinese characters sufficient to enable typical communication to a Chinese reader.

17. The device of claim 16, comprising a touch screen and the touch locations being virtual locations on the touch screen.

18. The device of claim 16, comprising a keyboard and the touch locations are physical keys of the keyboard.

19. A computer program product tangibly stored on a computer readable storage device, the computer program product comprising instructions for causing a processor to:
upon receipt of an indication that one or more of non-numerically associate touch locations have been invoked, access a database that stores a complete set of shape elements from which all Chinese characters in a set of Chinese characters that are sufficient to enable typical communication to a Chinese reader, the shape elements being organized in groups that are associated with the respective non-numerical touch locations, every one of the shape elements belonging to one of the groups, all shape elements in each group resembling each other in shape,
construct a Chinese character based on the shape elements of the database that are associated with the invoked touch locations, the constructed Chinese character being any of the set of Chinese characters sufficient to enable typical communication to a Chinese reader.

20. The computer program product of claim 19, wherein the computer program product comprises instructions for causing the processor to update the database with additional Chinese characters or phrases in association with sequences of touch locations.
